(19) United States
(12) Patent Application Publication
(10) Pub. No.: US 2017/0140915 A1
(43) Pub. Date: May 18, 2017

(54) SYSTEM AND METHOD FOR REDUCING THE SPACE CHARGE EFFECT IN A LINEAR ION TRAP

(71) Applicant: BEIJING INSTITUTE OF TECHNOLOGY, Beijing (CN)

(72) Inventors: Wei XU, Beijing (CN); Lili HU, Beijing (CN); Yuzhuo WANG, Beijing (CN)

(21) Appl. No.: 15/293,555

(22) Filed: Oct. 14, 2016

(30) Foreign Application Priority Data
Oct. 14, 2015 (CN) 201510662982.5

(51) Int. Cl. H01J 49/42; H01J 49/00

(52) U.S. Cl. CPC H01J 49/4265; H01J 49/4225; H01J 49/0027

(57) ABSTRACT

The present invention provides a system and a method for reducing the space charge effect in a linear ion trap. The system includes a linear ion trap, a first AC power supply, a second AC power supply, and a RF power supply. The linear ion trap includes four identical electrode rods, where two poles of the first AC power supply are respectively connected to two of the electrode rods, and two poles of the second AC power supply are respectively connected to the other two electrode rods. Two poles of the RF power supply are respectively connected to the first AC power supply and the second AC power supply. The first AC power supply and the second AC power supply provide sinusoidal AC signals. The present invention reduces the resolution decrease caused by the space charge effect, thereby improving analytical performance in mass spectroscopy.

### CROSS REFERENCE TO RELATED APPLICATION

This application claims priority to Chinese Patent Application No. 201510662982.5, filed Oct. 14, 2015, the disclosure of which is incorporated herein by reference in its entirety.

### TECHNICAL FIELD

The present invention relates to the field of mass spectrometry analysis, and more particularly to a system and a method for reducing the space charge effect in a linear ion trap.

### BACKGROUND ART

A mass spectrometry system typically includes a sample introducing system, an ion source, a mass analyzer, a detector, a data processing system, etc. The linear ion trap as a mass analyzer entraps the ions to be detected and selectively ejects target ions according to the motion characteristics of the ions in the electric field, which are analyzed by the detector. The linear ion trap uses a closed AC/DC RF electric field to entrap the ions, the electric signal part of some common linear ion traps usually has only an AC signal for selective excitation and release of a certain kind of ions.

However, the ion trap performance is affected by the space charge effect, which refers to the fact that when a large number of ions gather in an ion trap, charged ions form an ion cloud, and the charges in the outer layers of the ion cloud shield the charges in the inner layers and interfere with the effect of the ion trap electric field on the internal ions in the cloud. Thus, the space charge effect can affect the trajectory of ions, thereby resulting in decreased ion analytical performance.

### SUMMARY OF THE INVENTION

To overcome the above technical problems, the present invention provides a system and a method for reducing the space charge effect in a linear ion trap, which can reduce the decrease of resolution caused by the space charge effect and improve analytical performance.

To achieve the above objects, the present invention provides a system of reducing the space charge effect in a linear ion trap, which comprises:

a linear ion trap, a first AC power supply, a second AC power supply, a RF power supply;

said linear ion trap comprises four identical electrode rods, two poles of the first AC power supply are respectively connected to two electrode rods that are oppositely arranged in said linear ion trap, wherein two poles of the second AC power supply are respectively connected to the other two electrode rods, the RF voltage signals generated by two poles of the RF power supply are respectively coupled with the AC voltage signals generated by the first AC power supply and the second AC power supply; and wherein the first AC power supply and second AC power supply generate sinusoidal AC signals.

In an embodiment, the first AC power supply and the second AC power supply have a phase difference of 0° to 180°.

In an embodiment, the first AC power supply and the second AC power supply have a phase difference of 90°.

In an embodiment, said linear ion trap further comprises a ring encircling the four electrodes, and end caps disposed at the front and rear ends of said four electrode rods, wherein said end caps comprise a plurality of through holes.

In an embodiment, the first AC power supply and second AC power supply have signal frequencies of 50 Hz-500 Hz, and signal amplitudes of 0.5V-50V.

In an embodiment, said RF power supply has a signal frequency of 0.8 MHz-1.2 MHz and a signal amplitude of 200V-5000V.

The present invention further provides a method for reducing the space charge effect in a linear ion trap used in any of aforesaid systems and comprises:

emitting ions to be detected to a linear ion trap;

regulating the voltage of the RF power supply to make the ions to be detected entrapped in the linear ion trap, wherein the voltage and frequency of the RF power and motion characteristics of the ions to be detected satisfy the stability conditions of the Matthew equation;

turning on the first AC power supply and the second AC power;

regulating the signal frequency of said first and said second AC power supply to cause resonance of target ions in the ions to be detected, thereby ejecting the target ions from the linear ion trap.

In an embodiment, said method further comprises using a detector to detect the target ions ejected from the linear ion trap.

In an embodiment, the first AC power supply and second AC power supply have signal frequencies of 50 Hz-500 Hz, and signal amplitudes of 0.5V-50V.

In an embodiment, the RF power supply has a signal frequency of 0.8 MHz-1.2 MHz and a signal amplitude of 200V-5000V.

In the system and method for reducing the space charge effect in a linear ion trap described in the examples of the present invention, the linear ion trap includes four identical electrode rods, two poles of the first AC power supply are respectively connected to two electrode rods that are oppositely arranged in the ion trap, two poles of the second AC power supply are respectively connected to the other two electrode rods, the RF voltage signals generated by two poles of the RF power supply are respectively coupled with the AC voltage signals generated by the first AC power supply and the second AC power, the first AC power supply and the second AC power supply generate sinusoidal AC signals, thereby constituting dual-direction dipolar AC power supply, increasing the vibration amplitude of the ions in the linear ion trap, expanding the motional amplitude of the ions in the electric field, weakening the Coulomb force exerted on the ions when the ions move away from the ion cloud center, and decreasing the space charge effect on ion movement trajectories. At this time, by regulating the frequencies of the electrical signal to make the electrical signal frequencies approximate the movement frequencies of the ions, the ions that resonate with the electrical signal frequencies can be selected, which enables ion analysis and reduce the problems such as mass drift and resolution decrease due to the space charge effect.

### BRIEF DESCRIPTION OF THE DRAWINGS

FIG. 1 is a schematic diagram of a system for reducing the space charge effect in a linear ion trap according to embodiments of the present invention;

FIG. 2 is a schematic diagram of a linear ion trap according to certain embodiments of the present invention;

FIG. 3a is a simulation diagram of the trajectory of a single ion in a linear ion trap under mono-direction dipolar AC, FIGS. 3b-3e are the simulation diagrams of the trajectories of a single ion in a linear ion trap under dual-direction dipolar AC;

FIGS. 4a-4e are mass spectra peak comparison diagrams under mono-direction dipolar AC and dual-direction dipolar AC;

FIGS. 5a-5h are mass spectra comparison diagrams of reserpine under mono-direction dipolar AC and dual-direction dipolar AC;

FIGS. 6a-6d are PEG spectrograms of different injection time under mono-direction dipolar AC;

FIGS. 6e-6h are PEG spectrograms of different injection time under dual-direction dipolar AC;

FIG. 7 is a relationship diagram between the resolution of reserpine mass spectrogram and injection time;

FIG. 8 is a mass drift comparison diagram under mono-direction dipolar AC and dual-direction dipolar AC.

### DETAILED DESCRIPTION OF EMBODIMENTS

Certain embodiments of the present invention are illustrated below with reference to the drawings. Elements and features described in one drawing or one embodiment of the present invention may be combined with elements and features described in one or more other drawings or embodiments. It should be noted that for the purpose of clarity, expressions and descriptions of components or processes that are well known to those skilled in this art are omitted from the drawings and statements.

The present invention is further described below with reference to the drawings.

According to some embodiments, the present invention provides a system of reducing the space charge effect in a linear ion trap, as shown in FIG. 1, which comprises a linear ion trap, a first AC power supply, a second AC power supply, a RF power supply.

The linear ion trap comprises four identical electrode rods, as shown in FIG. 1. The first AC power supply, which is coupled with the RF power supply, is connected to two electrode rods that are spaced apart in said linear ion trap. The second AC power supply, which is also coupled with the RF power supply, is connected to the other two electrode rods. On the X-Y coordinate axis with O as the origin, electrode rod 11 and electrode rod 12 are disposed symmetrically on the X-axis with respect to point O point as the center, electrode rod 13 and electrode rod 14 are symmetrically disposed on the Y-axis with respect to point O as the center. The distance from the electrode 11 to the center of the field is x₀, as is the distance from the electrode rod 12 to the center of the field. The distance from the electrode 13 to the center of the field is y₀, as is the distance from the electrode rod 14 to the center of the field. The cross-sectional radius of each of the four electrode rods is rd.

Two poles of the first AC power supply AC1 are connected to the electrode rods 11 and 12, respectively, two poles of the second AC power supply AC2 are connected to the electrode rods 13 and 14. AC1 and AC2 constitutes a dual-direction dipolar AC power supply.

Two poles of the RF power supply are connected to the first AC power supply and the second AC power supply, respectively.

The first and second AC power supply generate sinusoidal AC signals. The phase difference between the first AC power supply and the second AC power supply is between 0° and 180°. Specifically, the phase difference may be 90°.

In an embodiment, rd may be 6 mm, the field radius x₀=y₀=5.33 mm.

In an embodiment, the signal frequency of AC1 and AC2 may be 50 Hz-500 Hz, the signal amplitude of AC1 and AC2 may be 0.5V-50V. The frequency of the RF power supply may be 0.8 MHz-1.2 MHz, and the signal amplitude may be 200V-5000V.

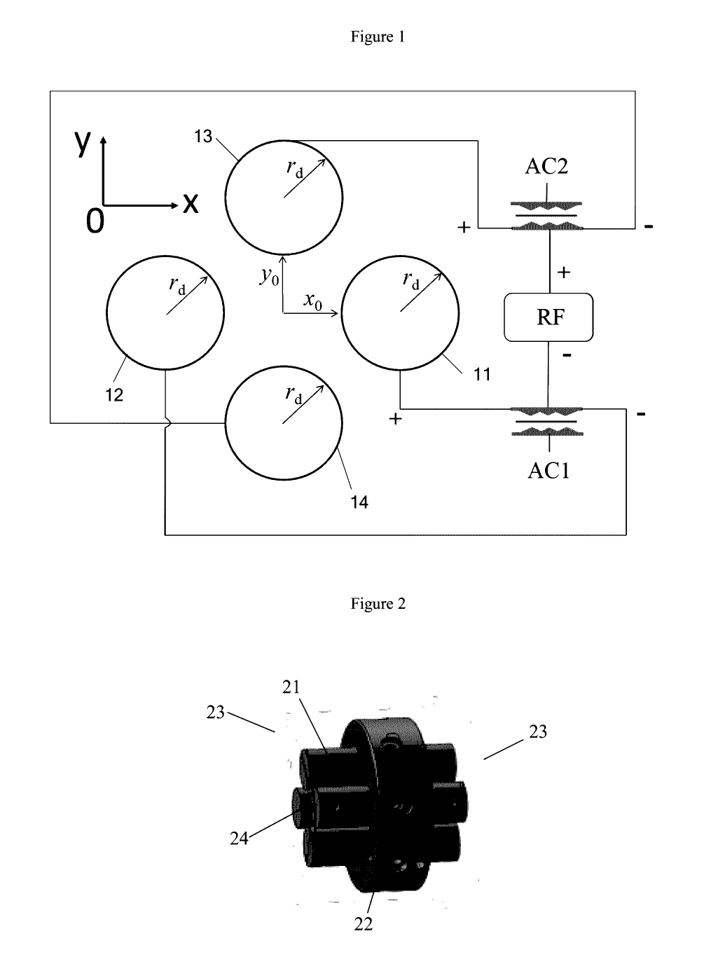

Further, as shown in FIG. 2, four electrode rods 21 can be held together by an external ring 22, and the front and rear ends of the electrode rods can be closed and fixed by end caps 23. If the ion trap ejects ions axially, the detector can be placed at the center of the end caps through hole 24; if radial ejection is used, the detector can be placed at the corresponding side ejection holes of the ion trap.

The system described in the examples of the invention includes four identical electrode rods and an electrical signal portion, where the dual-direction dipolar AC (AC1 and AC2) and a radio frequency signal RF constitute the electrical signal portion. The four electrode rods are fixed by an external ring and end caps at both ends. The dual-direction dipolar AC is connected to the two pairs of electrodes that are symmetrically arranged on the x- and y-axis (see FIG. 1). AC1 and AC2 provide sine/cosine AC signals. The dual-direction dipolar AC increases the vibration amplitude of the ions, expands the range of motion of the ions in the electric field, weakens the Coulomb force exerted on the ions when the ions move away from the ion cloud center, and decreases the space charge effect on the ion trajectories. At this time, by regulating the frequency of the electrical signal to make the electrical signal frequencies approximate the frequencies of the movement of ions, the resonant ions can be selected, which enables ion analysis and reduces the problems such as mass drift and resolution decrease due to space charge effect. Moreover, the structure and connection of the electrical signal portion of the system according to examples of the present invention are also relatively simple.

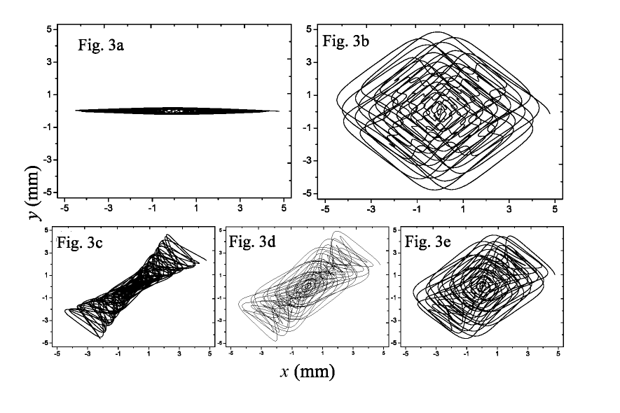

The system of the present invention is suitable for a variety of mass analyzers and other mass spectrometry systems. FIGS. 3a-3e show test results by axial ejection. Similar results are obtainable by radial ejection.

FIGS. 3a-3e shows simulation trajectories of a single ion in the electric field. The ions in this simulation test have a mass to charge ratio m/z of 195Th, the initial position (x₀, y₀)=(0.1, 0.1) mm, AC1 and AC2 of dual-direction dipolar AC have the same voltage and frequency, wherein the voltage U=750 mV, the frequency f=234 KHz. In practical applications, AC1 and AC2 may use other voltages and/or frequencies. Helium gas is injected into the vacuum ion trap to make the pressure reach 1 mTorr to absorb kinetic energy of the ions and reduce ion loss through ion collisions with helium. A large number of ions into the ion trap aggregate at the center of the trap to form an ion cloud. Under mono-direction dipolar AC, the single ion trajectory in the x-y plane is projected to an approximate straight line. At this time, the ions in the ion cloud shuttle and vibrate back and forth, and are subjected to a relatively large space charge effect, see FIG. 3a. When using a dual-direction dipolar AC, the ion trajectory moves away from the center of the trap, and the space charge effect weakens compared with mono-direction dipolar AC. The degree of the weakening varies with the phase difference of AC1 and AC2. When the phase difference Δφ of dual-direction dipolar AC is 90°, the space charge effect is minimized, see FIG. 3b. FIGS. 3c-3e show the ion trajectories when Δφ is 0°, 30°, 60°, respectively. It can be seen in FIG. 3(a), ion movement is primarily limited to one direction. While in FIGS. 3b-3e, the ions have noticeable trajectories on both the x-axis and y-axis direction. The expansion of the range of motion helps reduce the space charge effect. The simulation results theoretically verify that dual-direction dipolar AC can reduce the space charge effect in a linear ion trap.

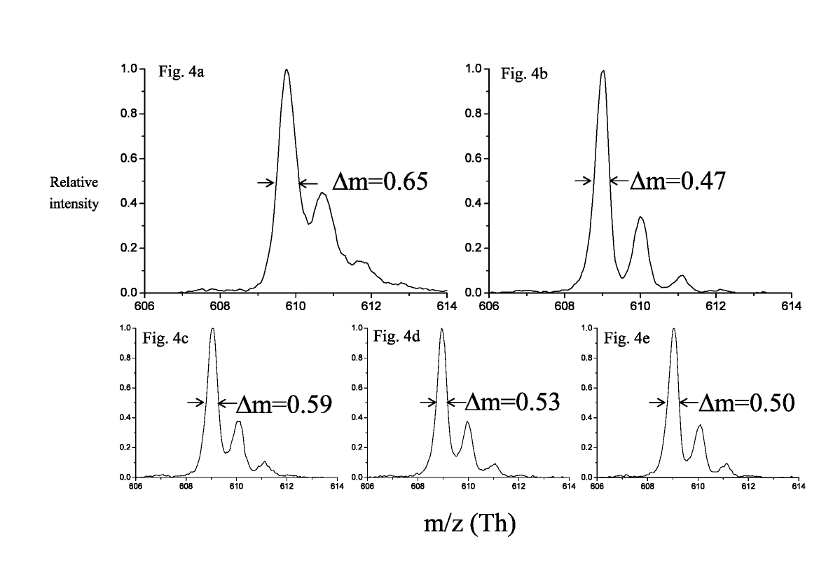

In mass spectroscopy, the reduction the space charge effect can be reflected in resolution improvement and mass drift suppression, as shown in FIG. 4, where the horizontal axis represents mass to charge ratio (m/z), and the vertical axis represents relative intensity. Wherein FIG. 4a is the mass spectra peak resolution under mono-direction AC. FIGS. 4b-4e, respectively, are the mass spectra peak resolutions when the phase differences Δφ between AC1 and AC2 in the dual-direction dipolar AC are 90°, 0°, 30°, 60°. Half peak width Δm is an important indicator to evaluate the mass spectra resolution—the narrower the half peak width, the higher the resolution. As can be seen from FIGS. 4a-4e, compared with mono-direction dipolar AC, the resolution under dual-direction dipolar AC is improved to varying degrees, and the half peak width when the dual-direction dipolar AC has a phase difference Δφ of 90° is significantly improved compared with the half peak width when mono-direction dipolar AC is used under the same condition.

According to some embodiments, the present invention further provides a method for reducing the space charge effect in a linear ion trap. The method can be used in any of the system described herein, and can include the steps of:

S01: turning on ion source and emitting ions to be detected to a linear ion trap;

S02: regulating the voltage of the RF power supply to make the ions to be detected entrapped in the linear ion trap;

The voltage and frequency of the RF power and the ions to be detected satisfy the stability conditions of Matthew equation, such that the ions to be detected are entrapped in the ion trap. For the principles of the Matthew equation and how the ions are entrapped in the ion trap based on the Matthew equation, a person of skill in the art can refer to “Quadrupole Ion Trap Mass Spectrometer,” authored by March, Ramond E.

The Matthew equation describes the alternating intensity q of the radio frequency RF, ion charge e, ion mass m, quadrupole radius r0, RF electric field amplitude V, RF electric field frequency Ω.

q is typically a fixed value; when r0 and q are constant, for each ion having a particular mass to charge ratio m/z, there is a unique set of V and Ω, so that the particular ions are entrapped in the quadrupole ion trap.

The signal frequency of the RF power supply typically can range from 0.8 MHz to 1.2 MHz, specifically, can be 1 MHz. The signal amplitude can range from 200V to 5000V.

S03: turning on the first power supply AC1 and the second AC power supply AC2;

The signal frequencies of AC1 and AC2 can range from 50 Hz to 500 Hz, the signal amplitude can range from 0.5V to 50V.

S04: regulating the signal frequencies of AC1 and AC2, when the signal frequency approximates the motion frequency of the target ions, the target ions acquire a greater vibration amplitude because of resonance and eject from the linear ion trap.

The regulation of the signal frequencies of AC1 and AC2 is used to cause the target ions in the ions to be detected resonate so as to obtain a greater motion amplitude and eject from the linear ion trap.

The method can further include a subsequent step S05: using a detector to detect the ions ejected from the linear ion trap.

The method for reducing the space charge effect in a linear ion trap in the embodiments of the present invention reduces the space charge effect in a linear ion trap by using dual-direction dipolar AC, thereby reducing resolution decrease when making mass spectroscopic analysis on the ions ejected from the ion trap and suppressing the mass drift to a certain extent.

In the following examples, reserpine and polyethylene glycol (PEG) are used as the target ions to illustrate the effects of embodiments of the present invention with reference to the drawings.

### Example 1

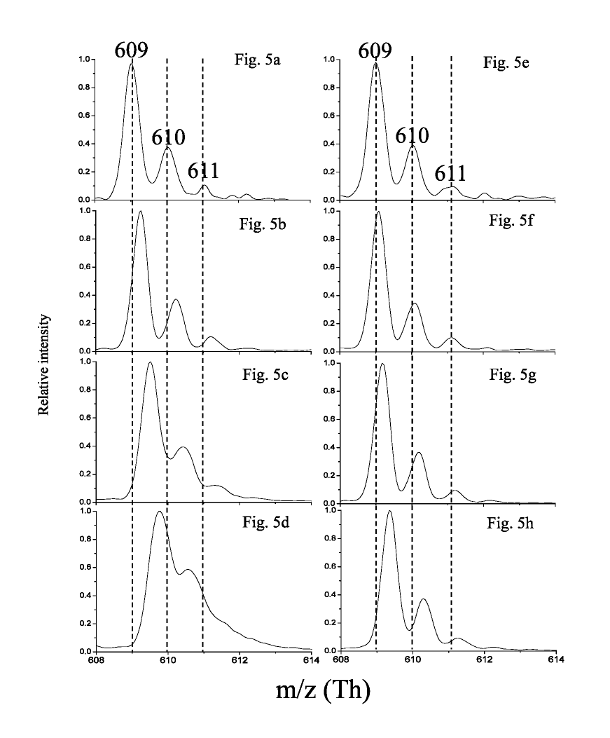

Reserpine is used in this example to show the mass spectrogram comparison between mono-direction dipolar AC and dual-direction dipolar AC. In FIGS. 5a-5h, the horizontal axis represents mass to charge ratio, and the vertical axis represents relative intensity. FIGS. 5a-5d represent mono-direction dipolar AC effect, and FIGS. 5e-5h represent dual-direction dipolar AC effect, FIGS. 5a and 5e have injection time of 35 ms, FIGS. 5b and 5f have injection time of 55 ms, FIGS. 5c and 5g have injection time of 75 ms, FIGS. 5d and 5h have injection time of 95 ms. In this example, the dual-direction dipolar AC have a phase difference Δφ=90°, a voltage U=500 mV, a frequency f=210 KHz.

FIGS. 5a-5h show three isotope peaks, i.e., at m/z of 609, 610 and 611.

According to the order of FIGS. 5a-5d, it can be found that the resolution of the mass spectrograms decreases gradually. This is because with the increase of injection time, the ions entering the linear ion trap increase, the space charge effect becomes more pronounced.

With reference to FIGS. 5a-5d, it can be seen that with the increase of injection time, the isotope peaks of the mass spectrograms under mono-direction dipolar AC are buried, whereas the peaks in FIGS. 5e-5h, which are obtained by dual-direction dipolar AC with same corresponding injection time, retains well-formed peaks. This is mainly because, with the increase of time, the mass drift under the dual-direction dipolar AC is better than the mass drift under mono-direction dipolar AC under the same conditions, thereby reducing the sharp decline in resolution to some extent.

### Example 2

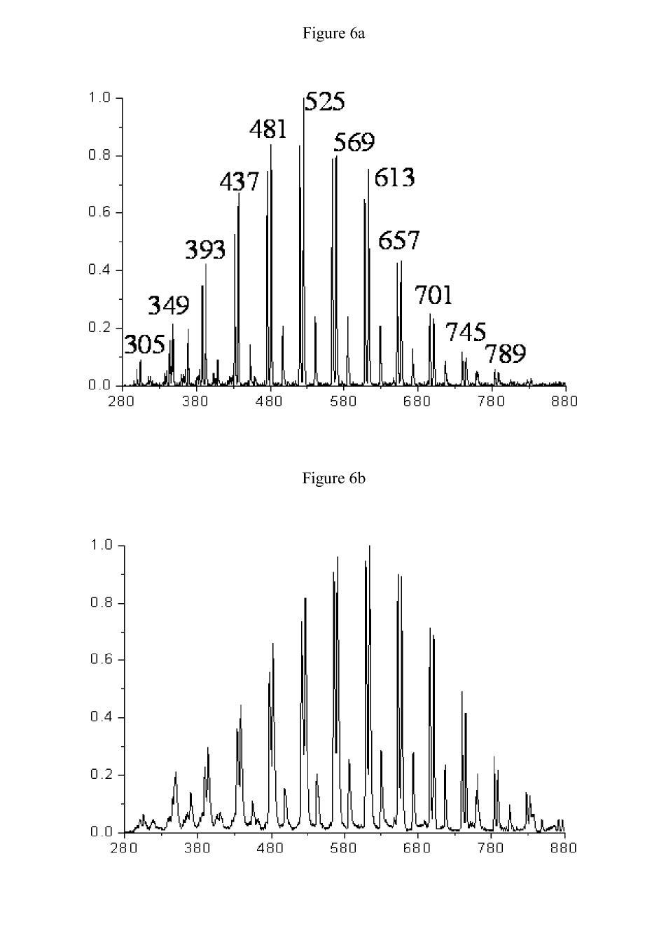

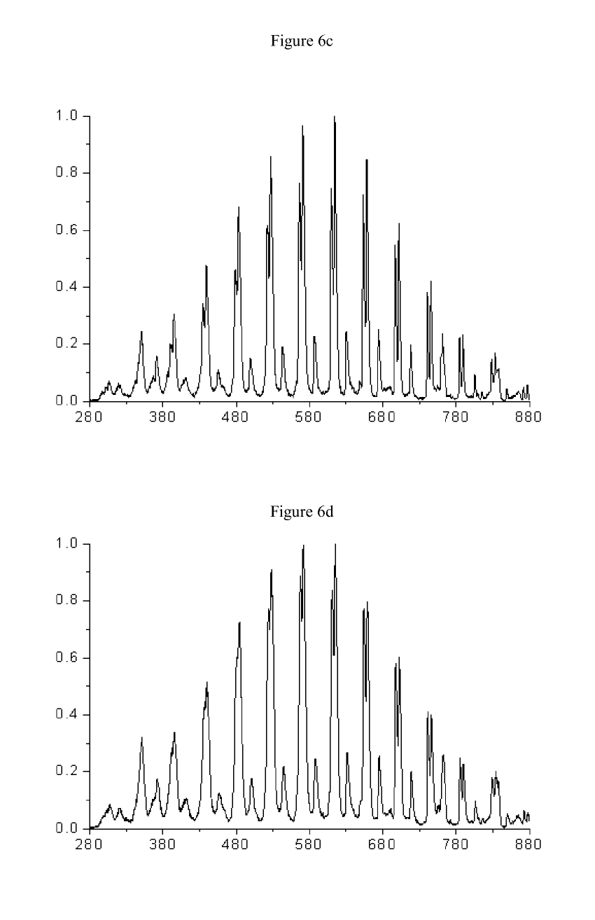

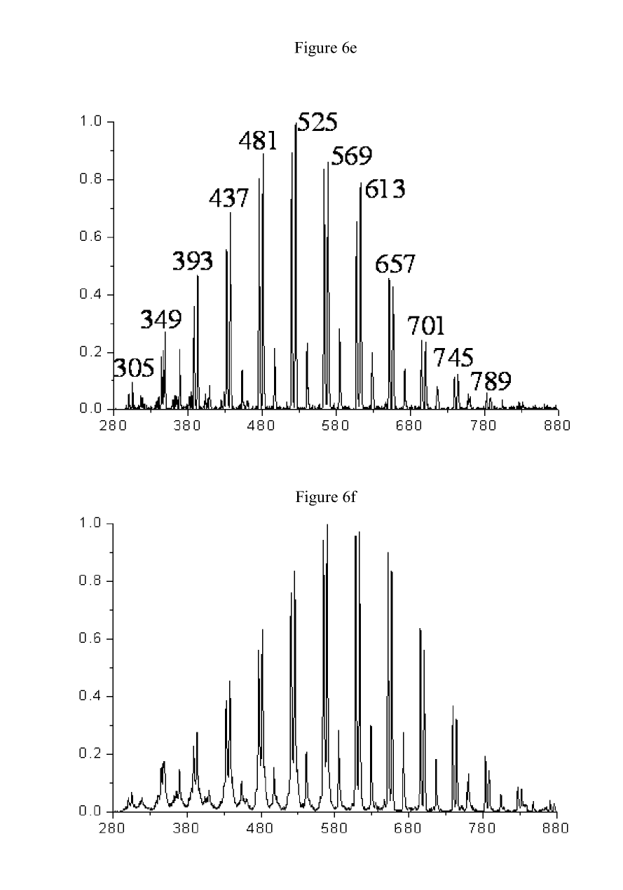

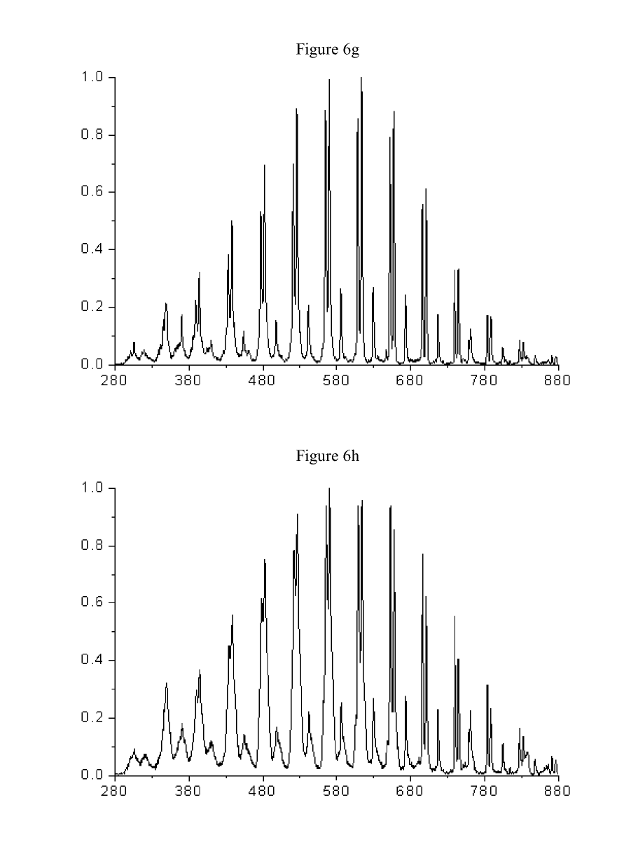

FIGS. 6a-6h are the mass spectrograms of PEG at different injection time, wherein the horizontal axis represents mass to charge ratio, and the vertical axis represents relative intensity. FIGS. 6a-6d show the effect of a mono-direction dipolar AC, and FIGS. 6e-6h show the effect of dual-direction dipolar AC. FIGS. 6a and 6e each have injection time of 15 ms, FIGS. 6b and 6f each have injection time of 45 ms, FIGS. 6c and 6g each have injection time of 75 ms, and FIGS. 6d and 6h each have injection time of 105 ms. In this example, the dual-direction dipolar AC have a phase difference Δφ=90°, a voltage U=500 mV, and a frequency f=210 KHz.

FIGS. 6a-6h show different mass peaks, e.g. 305, 349, 393, 437, 481, 525, 569, 613, 657, 701, 745, 789, etc.

With the increase of injection time, dual-direction dipolar AC has a slightly better inhibition in the mass drift at the low mass end than mono-direction dipolar AC. Thus, dual-direction dipolar AC has certain effect on the mass drift in the low-mass end.

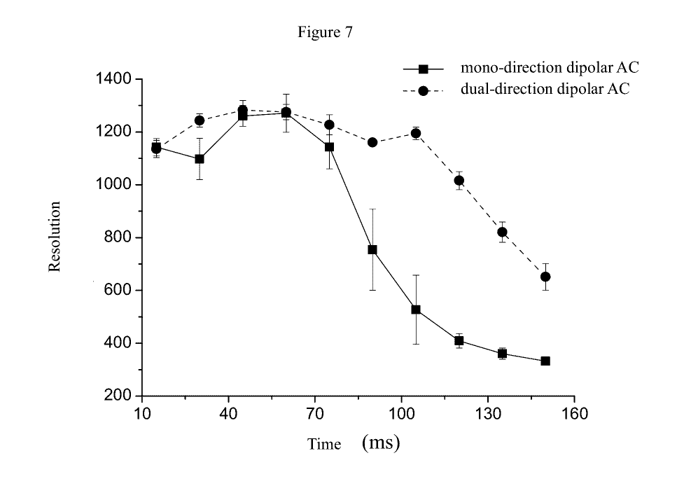

In addition, this example also provides the relationship diagram between the resolution of reserpine mass spectrogram and injection time, as shown in FIG. 7, where the horizontal axis represents time, and the vertical axis represents resolution. Overall, dual-direction dipolar AC (Δφ=90° in the entire measurement range has a greater advantage in resolution with the increase of injection time compared with mono-direction dipolar AC. When the injection time is longer than 70 ms, mono-direction dipolar AC shows significant resolution deterioration, while dual-direction dipolar AC eases the resolution deterioration to some extent due to the reduced space charge effect.

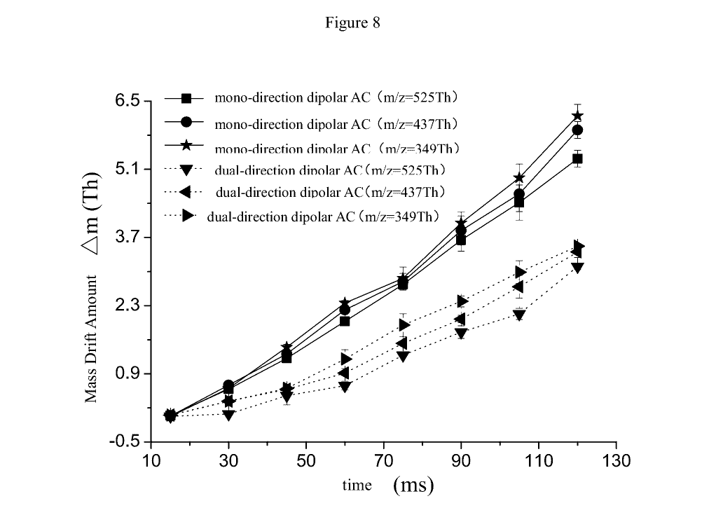

Furthermore, this example of the present invention provides the mass drift diagram of mono-direction dipolar AC and dual-direction dipolar AC (Δφ=90° of each PEG component for different injection time, as shown in FIG. 8, wherein the horizontal axis represents time and the vertical axis represents mass shift Δm. As can be seen from the FIG. 8, under the condition of the same injection time, the mass drift when using a dual-direction dipolar AC is significantly less than the mass drift when using a mono-direction dipolar AC. The ions with smaller mass to charge ratios are more susceptible to space charge effect and have greater mass shift than the ions with larger mass to charge ratios.

From the above, it can be seen that the embodiments of the system of the present invention include dual-direction dipolar AC, wherein two poles of AC1 are respectively connected to the electrode rods 11 and 12 symmetrically disposed on the X-axis, two poles of the second AC power supply AC2 are respectively connected to the electrode rods 13 and 14 symmetrically disposed on the Y-axis. Compared with using mono-direction dipolar AC, using the dual-direction dipolar AC to apply an electric field to the linear ion trap can reduce the space charge effect in the linear ion trap, improve the mass spectrogram resolution, and suppress the mass drift to some extent.

Although the invention and its advantages have been described in detail, it should be understood that without departing from the spirit and scope of the appended claims that various modifications, substitutions and changes can be made. Moreover, the scope of the present application is not limited to the specific examples of processes, systems, devices, methods and steps described in the specification. A person skilled in the art based on the disclosure of the present invention will readily understand that in accordance with the present invention one can use processes, systems, devices, methods and steps that are currently available or to be developed to implement similar functions as the corresponding examples described herein or obtain similar results. Therefore, the appended claims intend to include such processes, systems, devices, methods and steps within their scope.

1. A system of reducing the space charge effect in a linear ion trap, characterized by comprising:
a linear ion trap, a first AC power supply, a second AC power supply, a RF power supply;
wherein said linear ion trap comprises four identical electrode rods, two poles of the first AC power supply are respectively connected to two electrode rods that are oppositely arranged in said linear ion trap, two poles of the second AC power supply are respectively connected to the other two electrode rods, the RF voltage signals generated by two poles of the RF power supply are respectively coupled with the AC voltage signals generated by the first AC power supply and the second AC power supply; the first AC power supply and second AC power supply generate sinusoidal AC signals.

2. The system according to claim 1, wherein the first AC power supply and the second AC power supply have a phase difference of 0° to 180°.

3. The system according to claim 1, wherein the first AC power supply and second AC power supply have a phase difference of 90°.

4. The system according to claim 1, wherein said linear ion trap further comprises a ring encircling the four electrodes, and end caps disposed at the front and rear ends of said four electrode rods, where said end caps comprise a plurality of through holes.

5. The system according to claim 1, wherein the first AC power supply and second AC power supply have signal frequencies of 50 Hz-500 Hz, and signal amplitudes of 0.5V-50V.

6. The system according to claim 1, wherein said RF power supply has a signal frequency of 0.8 MHz-1.2 MHz and a signal amplitude of 200V-5000V.

7. A method for reducing the space charge effect in a linear ion trap, the method being used in a system of claim 1, the method comprising:
emitting ions to be detected to a linear ion trap;
regulating the voltage of the RF power supply to make the ions to be detected entrapped in the linear ion trap, wherein the voltage and frequency of said RF power and motion characteristics of the ions to be detected satisfy the stability conditions of the Matthew equation;
turning on the first AC power supply and the second AC power supply;
regulating the signal frequencies of the first AC power supply and the second AC power supply to cause resonance of the target ions in the ions to be detected, thereby ejecting the target ions from said linear ion trap.

8. The method according to claim 7, further comprising:
using a detector to detect the target ions ejected from the linear ion trap.

9. The method according to claim 7, wherein the first AC power supply and the second AC power supply have signal frequencies of 50 Hz-500 Hz, and signal amplitude of 0.5V-50V.

10. The method according to claim 7, wherein said RF power supply has a signal frequency of 0.8 MHz-1.2 MHz and a signal amplitude of 200V-5000V.
